(19) United States
(12) Patent Application Publication
(10) Pub. No.: US 2018/0348350 A1
(43) Pub. Date: Dec. 6, 2018

(54) Electronic Device for Determining the Distance of a Drone From an Obstacle With Filtering Adapted to the Speed of the Drone, Drone, Determination Method and Computer Program

(71) Applicant: Parrot Drones, Paris (FR)

(72) Inventors: Fabien Remond, L'Hay Les Roses (FR); Jerome Hourioux, Puteaux (FR)

(21) Appl. No.: 15/994,902

(22) Filed: May 31, 2018

(30) Foreign Application Priority Data
May 31, 2017 (FR) 1754828

(51) Int. Cl. G01S 7/527; G01S 15/10; G01S 15/93

(52) U.S. Cl. CPC G01S 7/5273; G01S 15/93; G01S 15/102

(57) ABSTRACT

An electronic device for determining a distance of a drone from an obstacle, the electronic device comprising:
an emission module to command the emission of an ultrasound signal toward the obstacle;
a reception module to receive a signal representative of an ultrasound signal reflected by the obstacle;
a calculation module to calculate the distance of the drone from the obstacle, from the received signal; and
a filtering module comprising at least one filter matched to a respective Doppler offset, each matched filter generating a respective filtered signal as a function of a convolution product of the emitted ultrasound signal, to which the respective Doppler offset is applied, with the received ultrasound signal;
   the calculation module then calculating the distance of the drone from the obstacle, from the filtered signal(s) from the filtering module.

### FIELD

The present invention relates to an electronic device for determining a distance of a drone from an obstacle. The electronic determination device comprises an emission module configured to command the emission of an ultrasound signal toward the obstacle, a reception module configured to receive a signal representative of an ultrasound signal reflected by the obstacle, and a calculation module configured to calculate a distance of the drone from the obstacle, from the received signal.

The invention also relates to a drone comprising such an electronic determination device.

The invention also relates to a method for determining a distance of a drone from an obstacle, the method being carried out by an electronic device.

The invention also relates to a non-transitory computer-readable medium including a computer program comprising software instructions which, when executed by a computer, implement such a determination method.

### BACKGROUND

The invention relates to the field of drones, i.e., remotely-piloted flying motorized apparatuses. The invention in particular applies both to fixed-wing drones as well as rotary-wing drones, such as quadricopters.

A drone comprising an electronic system for determining the distance of the aforementioned type is known from document EP 2,400,460 A1. The drone is a rotary-wing drone, able to be piloted using a portable electronic device, such as a smartphone or an electronic tablet.

The drone is provided with an ultrasound altimeter, emitting a beam toward the ground making it possible to determine the altitude of the drone relative to the ground at any moment. The ultrasound altimeter then forms an electronic device for determining the distance of the drone relative to the ground forming the obstacle.

The ultrasound altimeter, also called ultrasound telemeter, generally comprises an electroacoustic transducer generating an ultrasound beam toward the ground. The reflection of this beam on the ground then produces acoustic echoes that are received by a transducer, and a length of the acoustic path traveled is then calculated based on the length of time separating the emission of the beam from the reception of the first echo and the speed of the sound, thereby making it possible to estimate the altitude of the drone relative to the ground.

However, the distance provided by such an electronic determination device is not always very reliable, and the piloting of the drone is then sometimes a bit abrupt, in particular during the landing phase.

### SUMMARY OF THE INVENTION

The aim of the invention is then to propose an electronic device for determining a distance of a drone from an obstacle making it possible to calculate, more reliably and more precisely, the distance of the drone from the obstacle, and then making it possible to reduce any jolts during the piloting of the drone, in particular in the landing phase.

To that end, the invention relates to an electronic device for determining the distance of the aforementioned type, wherein the electronic determination device further comprises a filtering module comprising at least one filter matched to a respective Doppler offset, each matched filter being configured to generate a respective filtered signal as a function of a convolution product of the emitted ultrasound signal, to which the respective Doppler offset is applied, with the received ultrasound signal; the calculation module is then configured to calculate the distance of the drone from the obstacle, from the filtered signal(s) from the filtering module.

The filtering module comprising at least one filter matched to a respective Doppler offset, each matched filter being configured to generate a respective filtered signal as a function of a convolution product of the emitted ultrasound signal, to which the respective Doppler offset is applied, with the received ultrasound signal, then makes it possible to increase the signal-to-noise ratio of the signal provided to the calculation module.

The calculation module is then capable of calculating the distance of the drone from the obstacle, from the filtered signal(s) from the filtering module, more reliably and more precisely. With the electronic determination device, the resolution is then generally less than 10 cm.

The electronic determination device also makes it possible to have a better range, i.e., to increase the maximum value of the distance of the drone from the obstacle, which is determined for a given resolution, the determined distance for example being able to be up to 30 m for a resolution of 10 cm.

According to other advantageous aspects of the invention, the electronic determination device comprises one or more of the following features, considered alone or according to all technically possible combinations:
the filtering module comprises a plurality of filters each matched to a respective Doppler offset, arranged in parallel, the calculation module then being configured to calculate the distance of the drone from the obstacle, from filtered signals from the filtering module;
the device further comprises a selection module configured to select, based on a speed of the drone toward the obstacle, a matched filter from among the plurality of matched filters, the calculation module then being configured to calculate the distance of the drone from the obstacle, from the filtered signal from the selected matched filter;
the emission module is configured to command the emission of the ultrasound signal in the form of at least one frequency-modulated pulse,

each frequency-modulated pulse having a time duration preferably greater than or equal to 2 ms, more preferably greater than or equal to 4 ms, and still more preferably greater than or equal to 6 ms;
the emission module is further configured to command the emission of the ultrasound signal in the form of at least one non-frequency-modulated pulse, and the device further comprises a switching module configured to switch the emission module between a first emission mode of the ultrasound signal in the form of at least one frequency-modulated pulse and a second emission mode of the ultrasound signal in the form of at least one non-frequency-modulated pulse,

each non-frequency-modulated pulse having a time duration preferably less than or equal to

$$\frac{2 \times R}{c} ,$$

where R is a resolution with a predefined distance and c represents the speed of the sound in the air, such as a duration less than or equal to 1 ms;
the switching module is configured to switch the emission module between the first emission mode and the second emission mode, based on at least one property from among a distance between the drone and an obstacle and a signal-to-noise ratio associated with the last ultrasound signal reception(s),

the number of emissions in a given emission mode from among the first emission mode and the second emission mode preferably being greater than or equal to a predetermined minimum number, the predetermined minimum number preferably being greater than or equal to 3, more preferably equal to 4; and
the reception module comprises several reception channels arranged in parallel, each reception channel being configured to record the received signal with a respective gain value,

each gain value preferably being distinct from one reception channel to another.

The invention also relates to a drone comprising an electronic determination device configured to determine the distance of the drone relative to an obstacle, in which the electronic determination device is as defined above.

The invention also relates to a method for determining a distance of a drone from an obstacle, the method being carried out by an electronic device and comprising:
commanding the emission of an ultrasound signal toward the obstacle;
receiving a signal representative of an ultrasound signal reflected by the obstacle;
filtering (120) the received signal with at least one filter matched to a respective Doppler offset, each matched filter generating a respective filtered signal as a function of a convolution product of the emitted ultrasound signal, to which the respective Doppler offset is applied;
calculating the distance of the drone relative to the obstacle, from the filtered signal(s).

The invention also relates to a non-transitory computer-readable medium including a computer program comprising software instructions which, when executed by a computer, implement a determination method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of a drone, according to the invention, comprising an electronic device for determining a distance of the drone relative to an obstacle;

FIG. 2 is a partial schematic illustration of the electronic determination device of FIG. 1; and

FIG. 3 is a flowchart of a method, according to the invention, for determining the distance of the drone relative to the obstacle.

### DETAILED DESCRIPTION

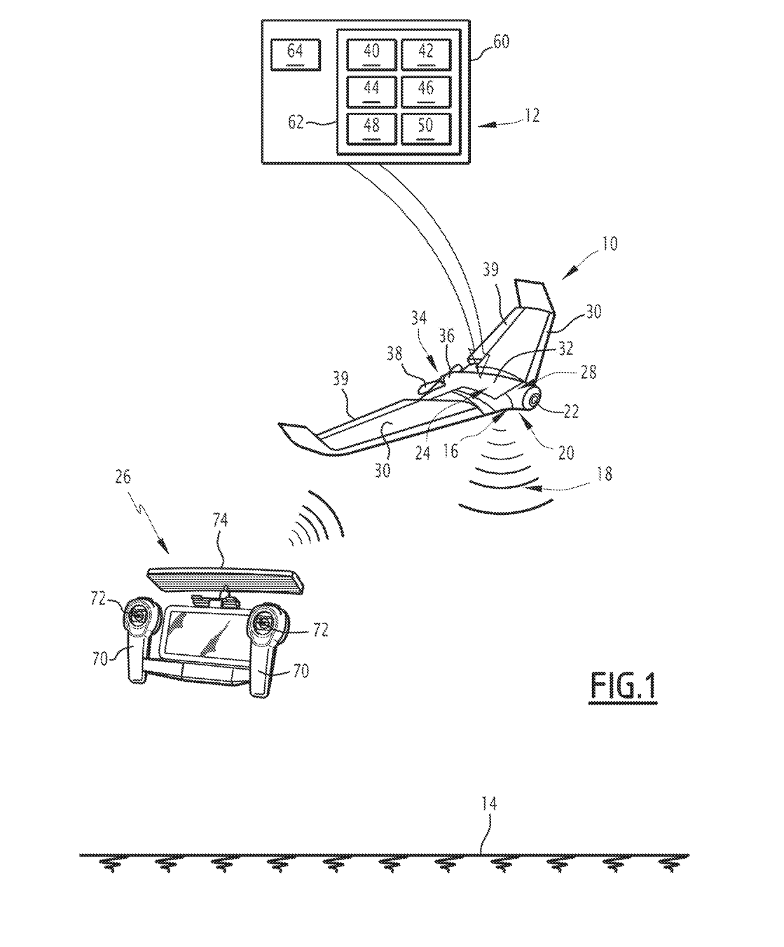

In FIG. 1, a drone 10, i.e., an aircraft with no pilot on board, comprises an electronic device 12 for determining a distance D of the drone 10 relative to an obstacle 14.

The drone 10 comprises at least one ultrasound transceiver 16 configured to emit ultrasound signals 18, in particular to emit an ultrasound signal 18 toward the obstacle 14, and to receive ultrasound signals reflected by the emitted signals, in particular to receive an ultrasound signal reflected by the obstacle 14.

In the example of FIG. 1, the obstacle 14 is terrain overflown by the drone 10, and the ultrasound transceiver 16 is then oriented downward, so as to be oriented toward the ground when the drone 10 is in flight. Alternatively or additionally, the obstacle 14 is an obstacle located in the movement direction of the drone, and the ultrasound transceiver 16 is then oriented forward, in order to point toward the obstacle 14 when the drone 10 is in flight.

The drone 10 preferably comprises two ultrasound transceivers 16 each configured to emit ultrasound signals 18, i.e., a first ultrasound transceiver oriented downward and a second ultrasound transceiver oriented forward.

Alternatively, the drone 10 comprises a single adjustable ultrasound transceiver 16, in particular able to be oriented alternately downward or forward, depending on the relevant flight phase of the drone 10.

The drone 10 comprises a first image sensor 20 configured to take a series of images of the terrain overflown by the drone 10. As an optional addition, the drone 10 comprises a second image sensor 22 configured to take images of a scene toward which the drone 10 is moving.

The drone 10 also comprises a measuring device 24 able to measure a speed of the drone 10. The measuring device 24 is for example a satellite positioning device, also called GNSS (Global Navigation Satellite System), or an inertial unit, also called IMU (Inertial Measurement Unit), comprising accelerometers and/or gyrometers, making it possible to measure angular speeds and attitude angles of the drone 10.

As an optional addition, the drone 10 comprises a pressure sensor, not shown, also called barometric sensor, configured to determine altitude variations of the drone 10, such as instantaneous variations and/or variations relative to a reference level, i.e., relative to a predefined initial altitude. The reference level is for example the sea level, and the pressure sensor is then able to provide a measured altitude of the drone 10 relative to the sea level.

As an optional addition, the drone 10 comprises a sensor, not shown, for measuring the airspeed of the drone, this measurement sensor being connected to a dynamic pressure tap of an element of the pitot tube type.

The drone 10 is a motorized flying vehicle able to be piloted remotely, in particular via a lever 26.

The drone 10 comprises a transmission module 28 configured to exchange data, preferably by radio waves, with one or several pieces of electronic equipment, in particular with the lever 26, or even with other electronic elements to transmit the image(s) acquired by the image sensors 20, 22.

In the example of FIG. 1, the drone 10 is a fixed-wing drone, of the sailwing type. It comprises two wings 30 and a fuselage 32 provided in the rear part with a propulsion system 34 comprising a motor 36 and a propeller 38. Each wing 30 is provided on the side of the trailing edge with at least one control surface 39 adjustable via a servomechanism, not shown, to control the trajectory of the drone 10.

In an alternative that is not shown, the drone 10 is a rotary-wing drone, comprising at least one rotor, and preferably a plurality of rotors, the drone 10 then being called multi-rotor drone. The number of rotors is for example equal to 4, and the drone 10 is then a quadrirotor drone.

The electronic determination device 12 is configured to determine the distance D of the drone 10 relative to the obstacle 14, i.e., to estimate a value of this distance D.

The electronic determination device 12 comprises an emission module 40 configured to command the emission of an ultrasound signal 18 toward the obstacle 14, a reception module 42 configured to receive a signal representative of an ultrasound signal reflected by the obstacle 14, and a calculation module 44 configured to calculate a distance D of the drone 10 from the obstacle 14, from the received signal.

The electronic determination device 12 further comprises, according to the invention, a filtering module 46 comprising at least one filter FD₁, FD₂, . . . , FD_{N} matched to a respective Doppler offset. The calculation module 44 is then configured to calculate the distance D from the filtered signal(s) from the filtering module 46.

As an optional addition, when the filtering module 46 comprises a plurality of filters FD₁, FD₂, . . . , FD_{N} each matched to a respective Doppler offset and arranged in parallel, the electronic determination device 12 preferably further comprises a selection module 48 configured to select, based on a speed V of the drone 10 toward the obstacle 14, a matched filter from among the plurality of matched filters FD₁, FD₂, . . . , FD_{N}. The calculation module 44 is then configured to calculate the distance D from the filtered signal from the selected matched filter.

When the speed V is not known, the set of matched filters FD₁, FD₂, . . . , FD_{N} is calculated and a matched filter FDᵢ is selected without this a priori speed information. The distance D thus estimated by the electronic determination device 12 is then less precise. In this case, however, the determination device 12 is further configured to estimate the speed of the drone 10 relative to the obstacle 14, this speed being determined owing to the selected filter number.

When the speed V is not known, the calculation module 44 is configured to select the matched filter FDᵢ from among all of the matched filters FD₁, FD₂, . . . , FD_{N} based on likelihood estimators. These likelihoods for example depend on the signal-to-noise ratio at the output of each matched filter FD₁, FD₂, . . . , FD_{N}.

As an optional addition, when the emission module 40 is able to command either the emission of the ultrasound signal in the form of at least one frequency-modulated pulse, or the emission of the ultrasound signal in the form of at least one non-frequency-modulated pulse, the electronic determination device 12 preferably further comprises a switching module 50 configured to switch the emission module 40 between a first emission mode M1 of the ultrasound signal in the form of at least one frequency-modulated pulse and a second emission mode M2 of the ultrasound signal in the form of at least one non-frequency-modulated pulse.

In the example of FIG. 1, the electronic determination device 12 comprises an information processing unit 60, for example made up of a memory 62 and a processor 64 associated with the memory 62.

When the considered obstacle 14 is a terrain, the terrain extends, within the general meaning of the term, as a portion of the Earth's surface when it involves outside terrain, whether it involves a land surface or a maritime surface, or a surface comprising both a land portion and a maritime portion. Alternatively, the terrain is inside terrain arranged inside a building. The terrain is also called ground.

Each ultrasound transceiver 16 comprises an electroacoustic transducer or an ultrasound transducer able to generate each ultrasound signal 18. The transceiver comprises an emitting transducer and another receiving transducer. Alternatively, the transceiver comprises a single transducer configured both to emit and receive ultrasound signals.

The first image sensor 20 is known per se and is for example a vertical camera pointing downward. The second image sensor 22 is for example a frontal camera.

The lever 26 is known per se and makes it possible to pilot the drone 10. In the example of FIG. 1, the lever 26 comprises two gripping handles 70, each being intended to be grasped by a respective hand of the pilot, a plurality of control members, comprising two joysticks 72, each being arranged near a respective gripping handle 70 and being intended to be actuated by the pilot, preferably by a respective thumb. Alternatively, not shown, the lever 26 is implemented by a smartphone or electronic tablet, as is known per se.

The lever 26 also comprises a radio antenna 74 and a radio transceiver, not shown, for exchanging data by radio waves with the drone 10, both uplink and downlink.

In the example of FIG. 1, the emission module 40, the reception module 42, the calculation module 44 and the filtering module 46, as well as, optionally and additionally, the selection module 48 and the switching module 50, are each made in the form of software executable by the processor 64. The memory 62 of the information processing unit 60 is then able to store emission software configured to command the emission of an ultrasound signal toward the obstacle 14, reception software configured to receive a signal representative of an ultrasound signal reflected by the obstacle 14, calculation software configured to calculate the distance D of the drone 10 from the obstacle 14 and filtering software configured to filter the received signal, with at least one filter FD₁, FD₂, . . . , FD_{N} matched to a respective Doppler offset, the calculation software then being configured to calculate the distance D from the filtered signal(s) from the filtering software. As an optional addition, the memory 62 of the information processing unit 60 is also suitable for storing selection software configured to select, based on the speed V of the drone 10 toward the obstacle 14, a matched filter from among the plurality of matched filters FD₁, FD₂, . . . , FD_{N}, the calculation software then being configured to calculate the distance D from the filtered signal from the selected matched filter. As an optional addition, the memory 62 of the information processing unit 60 is also suitable for storing switching software configured to switch the emission software between the first emission mode M1 of the sound signal in the form of at least one frequency-modulated pulse and the second emission mode M2 of the ultrasound signal in the form of at least one non-frequency-modulated pulse. The processor 64 of the information processing unit 60 is then able to execute the emission software, the reception software, the calculation software and the filtering software, as well as, optionally and additionally, the selection software and the switching software.

In an alternative that is not shown, the emission module 40, the reception module 42, the calculation module 44 and the filtering module 46, as well as, optionally and additionally, the selection module 48 and the switching module 50, are each made in the form of a programmable logic component, such as an FPGA (Field Programmable Gate Array), or in the form of a dedicated integrated circuit, such as an ASIC (Applications Specific Integrated Circuit).

When the determination device 12 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is a floppy disk, an optical disc, a CD-ROM, a magnetic-optical disc, a ROM memory, a RAM memory, any type of non-volatile memory (for example, EPROM, EEPROM, FLASH, NVRAM), a magnetic card or an optical card. A computer program comprising software instructions is then stored on the readable medium.

The emission module 40 is connected to the or each ultrasound transceiver 16, and is configured to send a command instruction to the corresponding ultrasound transceiver 16, in order to command the emission of an ultrasound signal 18 toward the obstacle 14.

According to the first emission mode M1, the emission module 40 is configured to command the emission of the ultrasound signal 18 in the form of at least one frequency-modulated pulse. According to the first emission mode M1, each frequency-modulated pulse is preferably a long pulse. A long pulse typically refers to a pulse of several ms. Each frequency-modulated pulse for example has a time duration Tp1 greater than 1 ms, preferably greater than or equal to 2 ms, more preferably greater than or equal to 4 ms, and still more preferably greater than or equal to 6 ms. The first emission mode M1 then corresponds to a pulse compression. The bandwidth of the modulation β is preferably chosen to be as large as allowed by the emission transducer. The emission transducers are limited in bandwidth to several kHz, typically 2 kHz for 40 kHz emitters. The obtained resolution is approximately equal to

$$\frac{c}{2 \times β}$$

if the product β*_{T} is large enough, typically greater than 20, τ being the emission duration. The first emission mode M1 is also called long-range emission mode.

According to the second emission mode M2, the emission module 40 is configured to command the emission of the ultrasound signal 18 in the form of at least one non-frequency-modulated pulse. According to the second emission mode M2, each non-frequency-modulated pulse is preferably a short pulse, and for example has a time duration Tp2 less than or equal to

$$\frac{2 \times R}{c} ,$$

where R is a resolution with a predefined distance and c represents the speed of the sound in the air, such as a duration less than or equal to 1 ms. The second emission mode M2 is also called short-range emission mode.

The reception module 42 is connected to the or each ultrasound transceiver 16, and is configured to receive, from the corresponding ultrasound transceiver 16, a signal representative of an ultrasound signal reflected by the obstacle 14, the ultrasound signal reflected by the obstacle 14 being received by said ultrasound transceiver 16.

The representative signal is for example a digital signal, the ultrasound signal reflected by the obstacle 14 and received by the ultrasound transceiver 16 then first being converted into an analog electrical signal by the corresponding transducer, and the analog electrical signal next being converted into the digital signal by an analog-digital converter.

As an optional addition, the reception module 42 comprises several reception channels, not shown, the reception channels being arranged in parallel. Each reception channel is configured to record the received signal with a respective gain value, each gain value preferably being distinct from one reception channel to another.

The calculation module 44 is configured to calculate the distance D of the drone 10 from the obstacle 14 from the received signal. The calculation principle of the distance D is known per se, and is based on the fact that the calculation module 44 knows both the propagation speed of the ultrasound signal in the air and the length of time that has elapsed between the emission and the reception of the ultrasound signal, and is then capable of deducing the distance D therefrom, the latter corresponding to half the distance traveled by the ultrasound signal to perform the round-trip between the drone 10 and the obstacle 14.

According to the invention, the calculation module 44 is configured to calculate the distance D from the filtered signal(s) from the filtering module 46. The calculation of the distance D is then done more reliably and more precisely, since the matched filtering makes it possible to increase the signal-to-noise ratio from the signal received at the input of the calculation module 44.

The filtering module 46 comprises at least one filter FD₁, FD₂, . . . , FD_{N} matched to a respective Doppler offset.

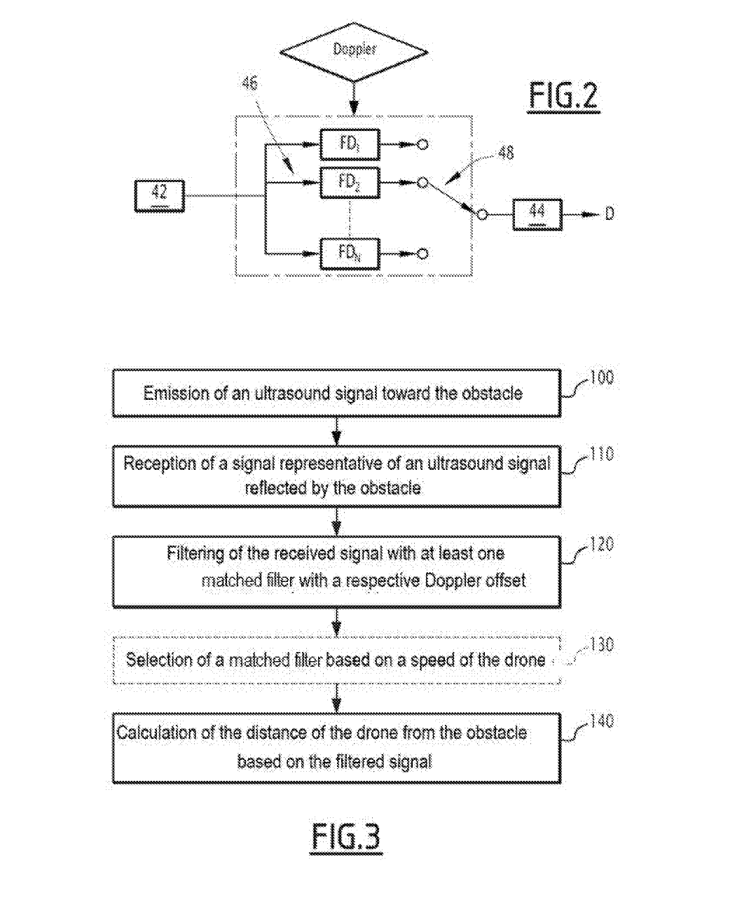

The filtering module 46 preferably comprises a plurality of filters FD₁, FD₂, . . . , FD_{N} each matched to a respective Doppler offset, the matched filters FD₁, FD₂, . . . , FD_{N} then being arranged in parallel, as shown in FIG. 2. The number N of matched filters FD₁, FD₂, . . . , FD_{N} is for example comprised between 1 and 25. The spacing between two successive matched filters FDⱼ, FDⱼ₊₁ will depend on the emission duration: the greater the latter is, the closer the matched filters FDⱼ, FDⱼ₊₁ will have to be in terms of Doppler frequency. Thus, the higher the emission duration is, the greater the number N of matched filters FD₁, FD₂, . . . , FD_{N} will be. In other words, the number N of matched filters FD₁, FD₂, . . . , FD_{N} is preferably an increasing function of the emission duration of the pulses. The maximum Doppler value to be represented by the extreme filters FD₁, FD_{N} will depend on the maximum relative speed achievable by the drone 10 with respect to the obstacle 14, value typically greater than 10 m/s.

Each matched filter FD₁, FD₂, . . . , FD_{N} is configured to generate a respective filtered signal as a function of a convolution product of the emitted ultrasound signal, to which the respective Doppler offset is applied, with the received ultrasound signal. Each filter FDᵢ is then matched to a particular Doppler.

Each matched filter FDᵢ, where i is an index comprised between 1 and N, verifies an equation of the type:

$${z}_{i} ( τ ) = {\int }_{- ∞}^{+ ∞} y ( t ) \cdot {s}_{{Doppler}_{i}}^{*} ( t - τ ) \cdot dt \qquad ( 1 )$$

where zᵢ(τ) represents the signal at the output of the matched filter with index i,

s_{Doppler}_{_}ᵢ(t−τ) represents the emitted signal to which a respective Doppler with index i has been applied,

yᵢ(t) represents the signal received at the input of the matched filter with index i, and is written in the form:

y(t)=A·s(t)+n(t) (2)

with A an attenuation coefficient, n(t) representing the noise and s(t) represents the emitted signal.

When the filtering module 46 comprises a plurality of matched filters FD₁, FD₂, . . . , FD_{N}, the calculation module 44 is configured to calculate the distance D from different filtered signals from the filtering module 46. The calculation module 44 is then configured to determine the most relevant echo from among the different signals from the filtering module 46, and to deduce the distance D from the delay of this most relevant echo, i.e., the length of time that has elapsed between the emission and reception of this most relevant echo.

When the relative speed of the drone 10 with respect to the obstacle 14 is known, the calculation module 44 determines the most relevant echo on the output of the filter corresponding to the Doppler associated with the speed given a priori. The calculation module 44 is also configured to determine the most relevant echo on the adjacent filters as a function of the precision of the given speed.

When the speed is not known, the calculation module 44 is configured to determine the most relevant echo from among the N matched filters FD₁, FD₂, . . . , FD_{N}. The determination, by the calculation module 44, of the most relevant echo is done from different likelihood estimators. These likelihoods for example depend on the signal-to-noise ratio at the output of each matched filter FD₁, FD₂, . . . , FD_{N}.

If a matched filter is selected from among the plurality of matched filters FD₁, FD₂, . . . , FD_{N}, the calculation module 44 is further configured to calculate the distance D from the filtered signal from the selected matched filter. If applicable, the echo considered to be the most relevant is that provided by the selected matched filter, and the calculation module 44 is then similarly configured to calculate the distance D from the delay of this most relevant echo.

When the filtering module 46 comprises a plurality of matched filters FD₁, FD₂, . . . , FD_{N}, the selection module 48 is configured to select a matched filter FDᵢ from among this plurality of matched filters FD₁, FD₂, . . . , FD_{N}, as a function of the speed V of the drone 10 toward the obstacle 14.

The selection module 48 is for example configured to estimate a Doppler value from the speed V of the drone 10 toward the obstacle 14, then to select the matched filter FDᵢ corresponding to the Doppler having the value closest to this estimate. The speed V of the drone 10 is the speed in the direction of the obstacle 14, i.e., the speed in the direction passing through the drone 10 and the obstacle 14, for example corresponding to the line passing through a center of the drone 10, such as its center of gravity, and a center of the obstacle 14.

One skilled in the art will for example understand that, when the ultrasound transceiver 16 points forward, the speed V of the drone 10 toward the obstacle 14 is then a horizontal speed. The horizontal speed is for example provided by the measuring device 24, or alternatively calculated via an optical flow algorithm. This speed optionally comes from merging the latter.

The optical flow algorithm is known per se, and is generally used to estimate a ground speed, also called horizontal speed, from a predefined altitude of the drone relative to the ground, this predefined altitude being assumed to be substantially constant. The predefined altitude is for example provided by the pressure sensor. By taking the incline of the drone into account, a three-dimensional speed is further estimated, said speed then including a vertical speed.

The optical flow algorithm makes it possible to estimate a differential movement from one scene of an image to the following image, and different known methods exist for implementing the optical flow algorithm, for example the Lucas-Kanade method, the Horn-Schunk method, or the Farneback method. The optical flow algorithm is further able to be implemented in a so-called multi-resolution technique, suitable for estimating the optical flow with different successive image resolutions, starting from a low resolution up to a high resolution.

The optical flow algorithm is also able to be combined with another image processing algorithm, in particular with an algorithm of the corner detector type, in order to improve the estimate of the differential movement of the scene from one image to the next, as described in document U.S. Pat. No. 2,400,460 A1. Other examples of the implementation of an optical flow algorithm are also described in the documents “Optic-Flow Based Control of a 46 g Quadrotor” by Briod et al, “Optical Flow Based Velocity Estimation for Vision based Navigation of Aircraft” by Julin et al, and “Distance and velocity estimation using optical flow from a monocular camera” by Ho et al.

When the electronic determination device 12 tries in particular to determine the altitude of the drone 10 relative to the terrain, or ground, i.e., the distance D relative to the obstacle 14 that is then formed by the ground, the ultrasound transceiver 16 then points downward, i.e., toward the terrain, or toward the ground, and the considered direction toward the obstacle 14 is the vertical direction. The speed V of the drone 10 toward the obstacle 14 is then vertical speed, such as the vertical speed in the NED coordinate system, for example provided by the measuring device 24 or obtained via the speed sensor.

The switching module 50 is configured to switch the emission module 40 between the first emission mode M1 and the second emission mode M2, based on at least one property from among a distance between the drone 10 and the obstacle 14, such as a previously calculated value of the distance D, and a signal-to-noise ratio associated with the last ultrasound signal reception(s).

The switching module 50 is for example configured to switch based solely on the signal-to-noise ratio associated with the last ultrasound signal reception(s), this signal-to-noise ratio preferably being smoothed over the last receptions. This switching from only the signal-to-noise ratio is preferably done based on a comparison with predefined thresholds, these thresholds preferably having separate values, in order to have a hysteresis. As an example, the switching from the second emission mode M2 toward the first emission mode M1 is done when the signal-to-noise ratio is below 25 dB, and the switching from the first emission mode M1 back to the second emission mode M2 is done when the signal-to-noise ratio is greater than 40 dB.

Alternatively, the switching module 50 is configured to switch based solely on the last calculated value(s) of the distance D, the value of the distance D taken into account preferably being smoothed over the last calculated values of the distance D. Similarly, this switching from only the distance is for example done based on a comparison with predefined thresholds, these thresholds preferably having distinct values, in order to have a hysteresis. As an example, the switching from the second emission mode M2 to the first emission mode M1 is done when said distance is greater than 6 m, and the switching from the first emission mode M1 back to the second emission mode M2 is done when said distance is less than 5.5 m.

The switching module 50 is for example configured to switch based simultaneously on the signal-to-noise ratio associated with the last ultrasound signal reception(s) and the last calculated value(s) of the distance D, this signal-to-noise ratio preferably being smoothed over the last receptions and the value of the distance D taken into account also preferably being smoothed over the last calculated values of the distance D. Similarly, this switching from both the signal-to-noise ratio and only the distance is for example done based on a comparison with predefined thresholds, these thresholds preferably having distinct values, in order to have a hysteresis. As an example, the switching from the second emission mode M2 toward the first emission mode M1 is done when the signal-to-noise ratio is below 25 dB or when said distance is greater than 6 m. The following switching from the first emission mode M1 back to the second emission mode M2 is next done when the signal-to-noise ratio is greater than 40 dB or when said distance is less than 5.5 m.

As an optional addition, the switching module 50 is further configured to verify that the number of emissions, according to the current emission mode from among the first emission mode M1 and the second emission mode M2, is greater than or equal to a predetermined minimum number, before switching to the other emission mode. The predetermined minimum number of emissions according to the current emission mode is preferably greater than or equal to 3, still more preferably equal to 4. This minimal number makes it possible to avoid overly frequent switching from one emission mode to the other.

The operation of the drone 10, and in particular the electronic determination device 12, according to the invention will now be explained using FIG. 3, showing a flowchart of the determination method according to the invention.

During an initial step 100, the emission of an ultrasound signal via the corresponding transceiver 16 toward the obstacle 14 is commanded by the emission module 40.

The emission module 40 then commands this emission of the ultrasound signal in the form of a frequency-modulated pulse according to the first emission mode M1, or in the form of a non-frequency-modulated pulse according to the second emission mode M2.

As an optional addition, in particular given that the emission of the ultrasound signal in the form of a frequency-modulated pulse according to the first emission mode M1 is not very effective in a short range, the first emission mode M1 also being called long-range emission mode, while the second emission mode M2 is called short-range emission mode, the switching module 50 further switches, during this initial step 100, the emission mode 40 between the first emission mode M1 and the second emission mode M2, as a function of at least one property from among a distance between the drone 10 and the obstacle 14, such as the last calculated value(s) of the distance D, and a signal-to-noise ratio associated with the last ultrasound signal reception(s).

As previously described, the choice of the emission mode from among the first emission mode M1 and the second emission mode M2 is for example based solely on the signal-to-noise ratio, or solely on the distance, or on both the signal-to-noise ratio and the distance. This choice of the emission mode solely from the signal-to-noise ratio, or solely from the distance, or from both the signal-to-noise ratio and the distance, is for example made based on a comparison with predefined thresholds, these thresholds preferably having values different from those associated with switching from the first mode M1 to the second mode M2 on the one hand, and those associated with switching from the second mode M2 to the first mode M1 on the other hand, in order to have operation in hysteresis.

During the following step 110, the reception module 42 receives a signal representative of an ultrasound signal reflected by the obstacle 14.

As an optional addition, this reception 110 is preferably done via the plurality of reception channels arranged in parallel, each having a respective predefined gain value, which then makes it possible to record, simultaneously or sequentially, the different received signals, in order to exploit both the close echoes and the distant echoes. In other words, each predefined gain value is different from one reception chain to another. Put differently, each reception chain is associated with a unique predefined gain value.

The use of a plurality of reception channels according to this optional addition then makes it possible to increase the reception dynamics, both for emissions done according to the first emission mode M1 and for those done according to the second emission mode M2.

Each signal received by the reception module 42 is next filtered by the filtering module 46 during step 120, the filtering module 46 comprising at least one filter matched to a respective Doppler offset.

As an optional addition, this filtering is done using several matched filters FD₁, FD₂, . . . , FD_{N}, arranged in parallel with one another.

During a following optional step 130, and when the filtering module 46 comprises several matched filters FD₁, FD₂, . . . , FD_{N}, the selection module 48 selects, based on the speed V of the drone 10 toward the obstacle 14, a matched filter FDᵢ in particular from among the plurality of matched filters FD₁, FD₂, . . . , FD_{N}.

This optional selection 130 then makes it possible to rule out one or several received stray signals not corresponding to the speed V of the drone 10 toward the obstacle 14.

The distance D of the drone 10 from the obstacle 14 is lastly calculated, during the following step 140, by the calculation module 44 and based on the filtered signal(s) from the filtering module 46.

When the filtering module 46 comprises a single matched filter FD₁, the calculation module 44 receives a single filtered echo, and then calculates the distance D from the delay of this filtered echo.

When the filtering module 46 comprises several matched filters FD₁, FD₂, . . . , FD_{N}, the calculation module 44 calculates the distance D from different filtered echoes from the filtering module 46, determining the most relevant echo from among the different signals from the filtering module 46, then deducing the distance D from the delay of this most relevant echo. The calculation module 44 preferably further calculates the relative speed of the drone 10 with respect to the obstacle 14 from the Doppler of the matched filter FDᵢ having provided the most relevant echo.

If a matched filter is selected from among the plurality of matched filters FD₁, FD₂, . . . , FD_{N}, the calculation module 44 is further configured to calculate the distance D from the filtered signal from the selected matched filter.

Thus, the use of a matched filtering according to the invention makes it possible to increase the signal-to-noise ratio of the received signal, such that the filtered signal from the filtering module 46 has a signal-to-noise ratio with a value higher than that of the signal received at the input of the filtering module 46, which ultimately makes it possible to improve the precision and reliability of the calculation of the distance D. With the electronic determination device 12 according to the invention, the resolution is then typically less than 10 cm.

Furthermore, emitting the ultrasound signal in the form of a frequency-modulated pulse according to the first emission mode, i.e., with pulse compression, makes it possible to have a better range, i.e., to increase the maximum value of the distance D while keeping a good resolution R, the determined distance D typically being able to reach up to 30 m for a resolution R of 10 cm.

The length of time Tp1 preferably being significant, i.e., greater than 1 ms as previously indicated, makes it possible to increase the signal-to-noise ratio in reception, and therefore also to have a better range. One skilled in the art will, however, note that the greater the length of time Tp1 is, the smaller the frequency spacing between two successive matched filters FDᵢ, FDᵢ₊₁ must be, and the larger the number N of matched filters FD₁, FD₂, . . . , FD_{N} must be. The choice of the length of time Tp1 then results from a compromise between the desired range and the complexity of the filtering module 46, the latter increasing when the number N of matched filters FD₁, FD₂, . . . , FD_{N} increases.

The length of time Tp2 preferably being small, i.e., less than or equal to

$$\frac{2 \times R}{c}$$

as previously indicated, such as a length of time less than or equal to 1 ms, makes it possible to have a good resolution R, without requiring several matched filters FD₁, FD₂, . . . , FD_{N} arranged in parallel. In this case, the inverse of the length of time of the pulse, i.e., 1/Tp2, is high, and the determination of the distance D is then less sensitive to the Doppler effect.

Indeed, the Doppler is generally likely to disrupt the estimation of the value of the distance D, when it is greater than the inverse of the length of time of the pulse, i.e., when it is greater than 1/Tp, where Tp is the general notation designating the length of time of the pulse, irrespective of the type of pulse from among a frequency-modulated pulse and a non-frequency-modulated pulse. In other words, the shorter the time duration Tp of the pulse is, the less sensitive the determination of the distance D will be to the Doppler.

One skilled in the art will then understand that the switching module 50 further makes it possible to opt for the emission mode from among the first emission mode M1 and the second emission mode M2 that, when the determination of the distance D is done, is most appropriate to resolve the aforementioned issue.

The optional use of different frequency modulations of the emitted signal, according to the first emission mode M1, with pulse compression, further makes it possible to be more robust with respect to stray signals, or even other drones flying near the drone 10.

1. An electronic device for determining a distance of a drone from an obstacle, the electronic determination device comprising:
an emission module configured to command the emission of an ultrasound signal toward the obstacle;
a reception module configured to receive a signal representative of an ultrasound signal reflected by the obstacle;
a calculation module configured to calculate the distance of the drone from the obstacle, from the received signal;
wherein it further comprises:
a filtering module comprising at least one filter matched to a respective Doppler offset, each matched filter being configured to generate a respective filtered signal as a function of a convolution product of the emitted ultrasound signal, to which the respective Doppler offset is applied, with the received ultrasound signal;
the calculation module then being configured to calculate the distance of the drone from the obstacle, from the filtered signal(s) from the filtering module.

2. The electronic device according to claim 1, wherein the filtering module comprises a plurality of filters each matched to a respective Doppler offset, arranged in parallel, the calculation module then being configured to calculate the distance of the drone from the obstacle, from filtered signals from the filtering module.

3. The electronic device according to claim 2, wherein the device further comprises a selection module configured to select, based on a speed of the drone toward the obstacle, a matched filter from among the plurality of matched filters, the calculation module then being configured to calculate the distance of the drone from the obstacle, from the filtered signal from the selected matched filter.

4. The electronic device according to claim 1, wherein the emission module is configured to command the emission of the ultrasound signal in the form of at least one frequency-modulated pulse.

5. The electronic device according to claim 4, wherein the emission module is further configured to command the emission of the ultrasound signal in the form of at least one non-frequency-modulated pulse, and
wherein the device further comprises a switching module configured to switch the emission module between a first emission mode of the ultrasound signal in the form of at least one frequency-modulated pulse and a second emission mode of the ultrasound signal in the form of at least one non-frequency-modulated pulse.

6. The electronic device according to claim 5, wherein the switching module is configured to switch the emission module between the first emission mode and the second emission mode, based on at least one property from among a distance between the drone and an obstacle and a signal-to-noise ratio associated with the last ultrasound signal reception (s).

7. The electronic device according to claim 1, wherein the reception module comprises several reception channels arranged in parallel, each reception channel being configured to record the received signal with a respective gain value.

8. A drone comprising an electronic determination device configured to determine the distance of the drone relative to an obstacle,
wherein the electronic determination device is according to claim 1.

9. A method for determining a distance of a drone from an obstacle, the method being carried out by an electronic device and comprising:
commanding the emission of an ultrasound signal toward the obstacle;
receiving a signal representative of an ultrasound signal reflected by the obstacle;
calculating the distance of the drone from the obstacle, from the received signal;
wherein it further comprises:
filtering the received signal with at least one filter matched to a respective Doppler offset, each matched filter generating a respective filtered signal as a function of a convolution product of the emitted ultrasound signal, to which the respective Doppler offset is applied;
calculating the distance of the drone relative to the obstacle, from the filtered signal(s).

10. A non-transitory computer-readable medium including a computer program comprising software instructions which, when executed by a computer, carry out a method according to claim 9.

11. The electronic device according to claim 4, wherein each frequency-modulated pulse has a time duration greater than or equal to 2 ms.

12. The electronic device according to claim 11, wherein each frequency-modulated pulse has a time duration greater than or equal to 4 ms.

13. The electronic device according to claim 12, wherein each frequency-modulated pulse has a time duration greater than or equal to 6 ms.

14. The electronic device according to claim 5, wherein each non-frequency-modulated pulse has a time duration less than or equal to
$$\frac{2 \times R}{c} ,$$
where R is a resolution with a predefined distance and c represents the speed of the sound in the air.

15. The electronic device according to claim 14, wherein each non-frequency-modulated pulse has a time duration less than or equal to 1 ms.

16. The electronic device according to claim 6, wherein the number of emissions in a given emission mode from among the first emission mode and the second emission mode is greater than or equal to a predetermined minimum number.

17. The electronic device according to claim 16, wherein the predetermined minimum number is greater than or equal to 3.

18. The electronic device according to claim 17, wherein the predetermined minimum number is equal to 4.

19. The electronic device according to claim 7, wherein each gain value is distinct from one reception channel to another.
